(19) United States
(12) Patent Application Publication
(10) Pub. No.: US 2019/0091802 A1
(43) Pub. Date: Mar. 28, 2019

(54) METHOD FOR FORMING ARTICLE, METHOD FOR FORMING TURBINE BUCKET, AND TURBINE BUCKET

(71) Applicant: GENERAL ELECTRIC COMPANY, Schenectady, NY (US)

(72) Inventors: Jillian Jamison WOOLRIDGE, Spartanburg, SC (US); Robert Trent HULLENDER, Simpsonville, SC (US)

(21) Appl. No.: 15/713,857

(22) Filed: Sep. 25, 2017

(51) Int. Cl. B23K 26/30; F01D 5/14; F01D 5/20; F01D 5/28

(52) U.S. Cl. CPC B23K 26/30; F01D 5/147; F01D 5/20; F01D 5/28; B23K 2201/001; F05D 2230/234; F05D 2240/307; F05D 2300/17; F05D 2220/32

(57) ABSTRACT

A method for forming an article is disclosed, including laser welding a powder of an HTW alloy to a surface of a substrate along a weld path, forming a weld bead of the HTW alloy. The weld path is propagated along a weld direction, forming a cladding layer of the HTW alloy on the surface. The laser welding includes a laser energy density of at least about 11 kJ/cm², and laser welding the powder to the surface includes a welding speed of about 5-20 ipm. The weld path oscillates essentially nonparallel to a reference line, establishing a cladding width wider than the weld bead width. The weld bead contacts itself along each oscillation such that the cladding layer is continuous and essentially free of cracks. A turbine bucket is disclosed including a squealer tip having the cladding layer with a cladding layer thickness of at least about 0.2 inches.

### FIELD OF THE INVENTION

The present invention is directed to methods for forming articles, methods for forming turbine buckets, and turbine buckets. More particularly, the present invention is directed to methods for forming articles and methods for forming turbine buckets including laser welding a powder of a hard-to-weld alloy to form a cladding layer, and turbine buckets including a squealer tip having a cladding layer of a hard-to-weld alloy.

### BACKGROUND OF THE INVENTION

Hard-to-weld (HTW) alloys, due to their gamma prime and various geometric constraints, are susceptible to gamma prime strain aging, liquation and hot cracking. These materials are also difficult to join when the gamma prime phase is present in volume fractions greater than about 30%, which may occur when aluminum or titanium content exceeds about 3%. As used herein, an “HTW alloy” is an alloy which exhibits liquation, hot and strain-age cracking, and which is therefore impractical to weld in a repeatable manner without significant rework.

HTW alloys may be incorporated into various components of gas turbine engines such as airfoils, blades (buckets), nozzles (vanes), shrouds, combustors, rotating turbine components, wheels, seals, and other hot gas path components. Incorporation of these HTW alloys may be desirable due to often superior operational properties, particularly for certain components subjected to the most extreme conditions and stresses. Additionally, certain HTW alloys may impart advantageous oxidation and corrosion properties when applied as cladding layers to other alloys, such as cladding layers applied to turbine buckets to form squealer tips.

Application of HTW alloys as cladding layer presents significant challenges, particularly because certain HTW alloys tend to form undesirable cracks when a weld bead of such an alloy is applied to a surface in contact with a previously applied weld bead of the alloy. Such challenges inhibit the formation of continuous cladding layers by standard techniques, such as build-up by concentric weld beads, and further inhibit the formation of layers of the HTW alloys more than a single weld bead in thickness.

### BRIEF DESCRIPTION OF THE INVENTION

In an exemplary embodiment, a method for forming an article includes laser welding a powder of a metal alloy to a surface of a substrate along a weld path, forming a weld bead of the metal alloy having a weld bead width and a weld bead height. The weld path is propagated along a weld direction, forming a cladding layer of the metal alloy disposed on the surface having a cladding layer thickness. The metal alloy is an HTW alloy. The laser welding includes a laser energy density of at least about 11 kJ/cm². Laser welding the powder of the metal alloy to the surface of the substrate along the weld path includes a welding speed between about 5 ipm to about 20 ipm. The weld path oscillates essentially nonparallel relative to a reference line, establishing a cladding width wider than the weld bead width. The weld bead contacts itself along each oscillation such that the cladding layer is continuous. The cladding layer is essentially free of cracks.

In another exemplary embodiment, a method for forming a turbine bucket including a squealer tip includes laser welding a powder of a metal alloy to a surface of a substrate along a weld path, forming a weld bead of the metal alloy having a weld bead width and a weld bead height. The weld path is propagated along a weld direction, forming a cladding layer of the metal alloy disposed on the surface having a cladding layer thickness. The metal alloy consists essentially of, by weight: about 15% to about 17% chromium; about 4% to about 5% aluminum; about 2% to about 4% iron; about 0.002% to about 0.04% yttrium; up to about 0.5% manganese; up to about 0.2% silicon; up to about 0.1% zirconium; up to about 0.05% carbon; up to about 0.5% tungsten; up to about 2% cobalt; up to about 0.15% niobium; up to about 0.5% titanium; up to about 0.5% molybdenum; up to about 0.01% boron; and a balance of nickel. The surface of the substrate includes a surface layer of a surface material selected from the group consisting of: an alloy composition including, by weight: about 21% to about 23% chromium; about 13% to about 15% tungsten; about 1% to about 3% molybdenum; about 0.25% to about 0.75% manganese; about 0.2% to about 0.6% silicon; about 0.1% to about 0.5% aluminum; about 0.05% to about 0.15% carbon; about 0.01% to about 0.03% lanthanum; up to about 3% iron; up to about 5% cobalt; up to about 0.5% niobium; up to about 0.1% titanium; up to about 0.015% boron; and a balance of nickel; an alloy composition including, by weight: about 20% to about 23% chromium; about 8% to about 10% molybdenum; about 3.15% to about 4.15% niobium and tantalum; up to about 5% iron; up to about 0.1% carbon; up to about 0.5% manganese; up to about 0.5% silicon; up to about 0.015% phosphorous; up to about 0.015% sulfur; up to about 0.4% aluminum; up to about 0.4% titanium; up to about 1% cobalt; and a balance of nickel; an alloy composition including, by weight: about 14% to about 16% nickel; about 19% to about 21% chromium; about 8% to about 10% tungsten; about 4.0% to about 4.8% aluminum; about 0.1% to about 0.3% titanium; about 2% to about 4% tantalum; about 0.25% to about 0.45% carbon; about 0.5% to about 1.5% hafnium; about 0.35% to about 0.55% yttrium; and a balance of cobalt; and combinations thereof. The laser welding includes a laser energy density of between about 11.5 kJ/cm² to about 20.3 kJ/cm². Laser welding the powder of the metal alloy to the surface of the substrate along the weld path includes a welding speed between about 5 ipm to about 20 ipm. The powder is applied at a flow rate of between about 4.8 g/min to about 5.2 g/min. The weld path oscillates essentially nonparallel relative to a reference line, establishing a cladding width wider than the weld bead width. The weld bead contacts itself along each oscillation such that the cladding layer is continuous. The cladding layer is essentially free of cracks. The cladding layer forms at least a portion of the squealer tip. The weld path commences at a trailing edge of the turbine bucket, proceeds across a trailing edge width of the trailing edge, and then proceeds around a periphery of the turbine bucket along one of a suction side and a pressure side, through a leading edge, and back along the other of the suction side and the pressure side until returning to the trailing edge. The cladding layer thickness is at least about 0.2 inches. Forming the cladding layer is free of gas tungsten arc welding.

In another exemplary embodiment, a turbine bucket includes a squealer tip, and the squealer tip includes a cladding layer consisting essentially of, by weight: about 15% to about 17% chromium; about 4% to about 5% aluminum; about 2% to about 4% iron; about 0.002% to about 0.04% yttrium; up to about 0.5% manganese; up to about 0.2% silicon; up to about 0.1% zirconium; up to about 0.05% carbon; up to about 0.5% tungsten; up to about 2% cobalt; up to about 0.15% niobium; up to about 0.5% titanium; up to about 0.5% molybdenum; up to about 0.01% boron; and a balance of nickel. The cladding layer is essentially free of cracks, and the cladding layer includes a cladding layer thickness of at least about 0.2 inches.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is a perspective view of the formation of an article during formation of a cladding layer, according to an embodiment of the present disclosure.

FIG. 2 is a perspective view of the article of FIG. 1 following formation of the cladding layer, according to an embodiment of the present disclosure.

FIG. 3 is a perspective view of the formation of the article of FIGS. 1 and 2 during application of a second sub-layer of a plurality of sub-layers of the cladding layer, according to an embodiment of the present disclosure.

FIG. 4 is a plan schematic view of the weld path of the formation of the cladding layer of FIG. 1, according to an embodiment of the present disclosure.

FIG. 5 is a perspective view of an article having a cladding layer following an alternative weld path to FIGS. 1-4, according to an embodiment of the present disclosure.

FIG. 6 is a plan schematic view of the alternative weld path of FIG. 5, according to an embodiment of the present disclosure.

FIG. 7 is a cross-sectional view of the article formed in FIG. 2 wherein the substrate includes a surface layer of surface material, according to an embodiment of the present disclosure.

FIG. 8 is a cross-sectional view of the article formed in FIG. 2 wherein the surface of the substrate has the same composition as the substrate itself, according to an embodiment of the present disclosure.

Wherever possible, the same reference numbers will be used throughout the drawings to represent the same parts.

### DETAILED DESCRIPTION OF THE INVENTION

Provided are exemplary methods for forming article, methods for forming turbine buckets, and turbine buckets. Embodiments of the present disclosure, in comparison to articles and methods not utilizing one or more features disclosed herein, decrease costs, increase process control, increase process efficiency, increase process speed, increase repeatability, increase cladding layer thickness ranges, decrease squealer tip composition complexity, decrease or eliminate crack occurrence, or combinations thereof.

As used herein, “GTD 111” refers to an alloy including a composition, by weight, of about 13.5% to about 14.5% chromium, about 9% to about 10% cobalt, about 3.3% to about 4.3% tungsten, about 4.4% to about 5.4% titanium, about 2.5% to about 3.5% aluminum, about 0.05% to about 0.15% iron, about 2.3% to about 3.3% tantalum, about 1.1% to about 2.1% molybdenum, about 0.05% to about 0.15% carbon, and a balance of nickel. GTD 111 is available from General Electric Company, 1 River Road, Schenectady, N.Y. 12345.

As used herein, “GTD 222” refers to an alloy including a composition, by weight, of about 22.5% to about 24.5% chromium, about 18% to about 20% cobalt, about 1.5% to about 2.5% tungsten, about 0.3% to about 1.3% niobium, about 1.8% to about 2.8% titanium, about 0.7% to about 1.7% aluminum, about 0.5% to about 1.5% tantalum, about 0.15% to about 0.35% silicon, about 0.05% to about 0.15% manganese, and a balance of nickel. GTD 222 is available from General Electric Company, 1 River Road, Schenectady, N.Y. 12345.

As used herein, “HAYNES 214” refers to an alloy including a composition, by weight, of about 15% to about 17% chromium, about 4% to about 5% aluminum, about 2% to about 4% iron, about 0.002% to about 0.04% yttrium, up to about 0.5% manganese, up to about 0.2% silicon, up to about 0.1% zirconium, up to about 0.05% carbon, up to about 0.5% tungsten, up to about 2% cobalt, up to about 0.15% niobium, up to about 0.5% titanium, up to about 0.5% molybdenum, up to about 0.01% boron, and a balance of nickel. HAYNES 214 is available from H.C. Starck, 45 Industrial Place, Newton, Mass. 02461-1951.

As used herein, “HAYNES 230” refers to an alloy including a composition, by weight, of about 21% to about 23% chromium, about 13% to about 15% tungsten, about 1% to about 3% molybdenum, about 0.25% to about 0.75% manganese, about 0.2% to about 0.6% silicon, about 0.1% to about 0.5% aluminum, about 0.05% to about 0.15% carbon, about 0.01% to about 0.03% lanthanum, up to about 3% iron, up to about 5% cobalt, up to about 0.5% niobium, up to about 0.1% titanium, up to about 0.015% boron, and a balance of nickel. HAYNES 230 is available from Haynes International, 1020 W. Park Avenue, Kokomo, Ind., 46904-9013.

As used herein, “INCONEL 625” refers to an alloy including a composition, by weight, of about 20% to about 23% chromium, about 8% to about 10% molybdenum, about 3.15% to about 4.15% niobium and tantalum, up to about 5% iron, up to about 0.1% carbon, up to about 0.5% manganese, up to about 0.5% silicon, up to about 0.015% phosphorous, up to about 0.015% sulfur, up to about 0.4% aluminum, up to about 0.4% titanium, up to about 1% cobalt, and a balance of nickel. INCONEL 625 is available from Special Metals Corporation, 3200 Riverside Drive, Huntington, W. Va. 25720.

As used herein, “INCONEL 718” refers to an alloy including a composition, by weight, of about 17% to about 21% chromium, about 50% to about 55% nickel and cobalt, about 4.75% to about 5.5% niobium and tantalum, about 2.8% to about 3.3% molybdenum, about 0.65% to about 1.15% titanium, about 0.2% to about 0.8% aluminum, up to about 1% cobalt, up to about 0.08% carbon, up to about 0.35% manganese, up to about 0.35% silicon, up to about 0.015% phosphorous, up to about 0.015% sulfur, up to about 0.006% boron, up to about 0.3% copper, and a balance of iron. INCONEL 718 is available from Special Metals Corporation, 3200 Riverside Drive, Huntington, W. Va. 25720.

As used herein, “MAR-M-247” refers to an alloy including a composition, by weight, of about 5.4% to about 5.7% aluminum, about 8% to about 8.5% chromium, about 9% to about 9.5% cobalt, about 9.3% to about 9.7% tungsten, about 0.05% to about 0.15% manganese, about 0.15% to about 0.35% silicon, about 0.06% to about 0.09% carbon, and a balance of nickel. MAR-M-247 is available from MetalTek International, 905 E. St. Paul Avenue, Waukesha, Wis. 53188.

As used herein, “MERL 72” refers to an alloy including a composition, by weight, of about 14% to about 16% nickel, about 19% to about 21% chromium, about 8% to about 10% tungsten, about 4.0% to about 4.8% aluminum, about 0.1% to about 0.3% titanium, about 2% to about 4% tantalum, about 0.25% to about 0.45% carbon, about 0.5% to about 1.5% hafnium, about 0.35% to about 0.55% yttrium, and a balance of cobalt. MERL 72 is available from Polymet Corporation, 7397 Union Centre Boulevard, West Chester, Ohio, 45014.

As used herein, “René 108” refers to an alloy including a composition, by weight, of about 7.9% to about 8.9% chromium, about 9% to about 10% cobalt, about 5% to about 6% aluminum, about 0.5% to about 0.9% titanium, about 9% to about 10% tungsten, about 0.3% to about 0.7% molybdenum, about 2.5% to about 3.5% tantalum, about 1% to about 2% hafnium and a balance of nickel. René 108 is commercially available under that designation.

As used herein, “René N4” refers to an alloy including a composition, by weight, of about 9% to about 10.5% chromium, about 7% to about 8% cobalt, about 3.7% to about 4.7% aluminum, about 3% to about 4% titanium, about 1% to about 2% molybdenum, about 5% to about 7% tungsten, about 4.3% to about 5.3% tantalum, about 0.3% to about 0.7% niobium, about 0.1% to about 0.2% hafnium, and a balance of nickel. René N4 is commercially available under that designation.

As used herein, “René N5” refers to an alloy including a composition, by weight, of about 7% to about 8% cobalt, about 6% to about 8% chromium, about 5.5% to about 7.5% tantalum, about 5.2% to about 7.2% aluminum, about 4% to about 6% tungsten, about 2.5% to about 3.5% rhenium, about 1% to about 2% molybdenum, about 0.1% to about 0.2% hafnium, and a balance of nickel. René N5 is commercially available under that designation.

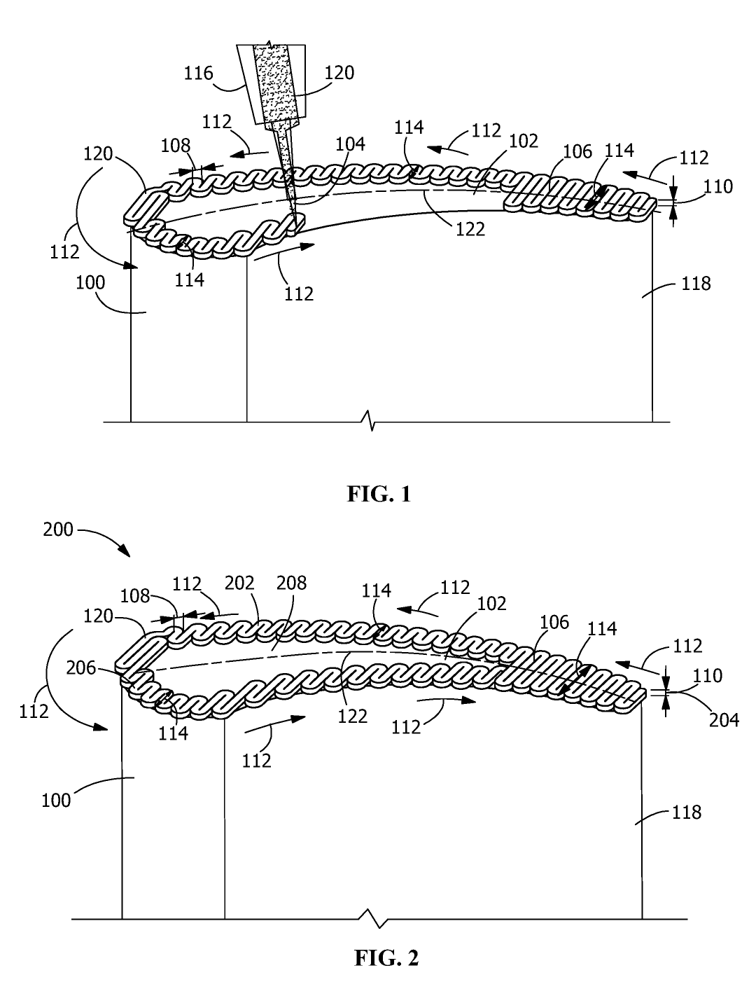

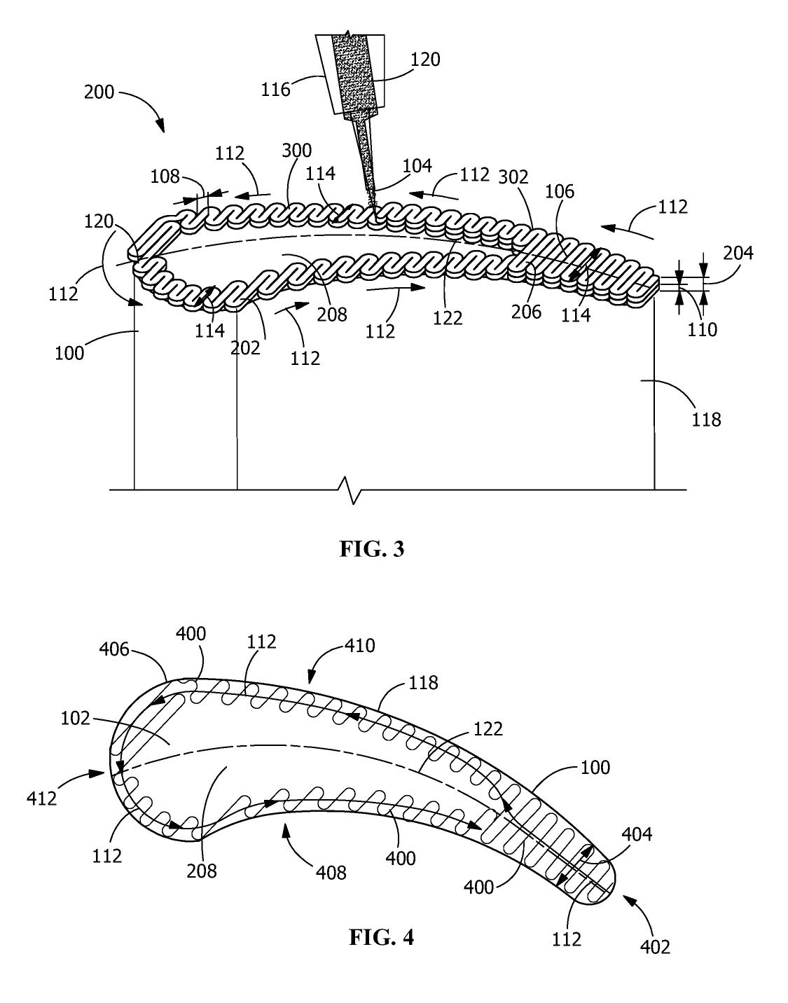

Referring to FIGS. 1-6, in one embodiment, a method for forming an article 200 includes laser welding a powder 104 of a metal alloy 120 to a surface 102 of a substrate 100 along a weld path 400, forming a weld bead 106 of the metal alloy 120 having a weld bead width 108 and a weld bead height 110. The weld path 400 propagates along a weld direction 112, forming a cladding layer 202 of the metal alloy 120 disposed on the surface 102 having a cladding layer thickness 204. The weld path 400 oscillates essentially nonparallel relative to a reference line 122, establishing a cladding width 114 wider than the weld bead width 108. The weld bead 106 contacts itself along each oscillation such that the cladding layer 202 is continuous. The cladding layer 202 is essentially free of cracks. In a further embodiment, forming the cladding layer 202 is free of gas tungsten arc welding.

The reference line 122 may be any suitable line, including, but not limited to, the weld direction 112, a chord line of the substrate 100, a center line of the substrate 100, or combinations thereof.

As used herein, the weld path 400 oscillating “essentially nonparallel” relative to the reference line 122 indicates that between each turn of the weld path 400, the weld path 400 progresses at an angle which is not parallel with respect to the reference line 122, excepting that in embodiments in which the reference line 122 progresses around a curve, there may a point along the curve at which the weld path 400 between two turns of the weld path 400 is parallel with the reference line 122. As used herein “not parallel” indicates an angle between 1° to 179°, alternatively between about 30° to about 150°, alternatively between about 60° to about 120°.

In one embodiment, the weld path 400 oscillates essentially perpendicular to the reference line 122. As used herein, “essentially perpendicular” indicates that that between each turn of the weld path 400, the weld path 400 progresses at an angle at less than about a 15° variance, alternatively less than about a 10° variance, alternatively less than about a 5° variance, excepting that in embodiments in which the weld direction 112 progresses around a curve, the essentially perpendicular oscillation of the weld path 400 may be oblique or even perpendicular to the weld direction 112 at points along the curve.

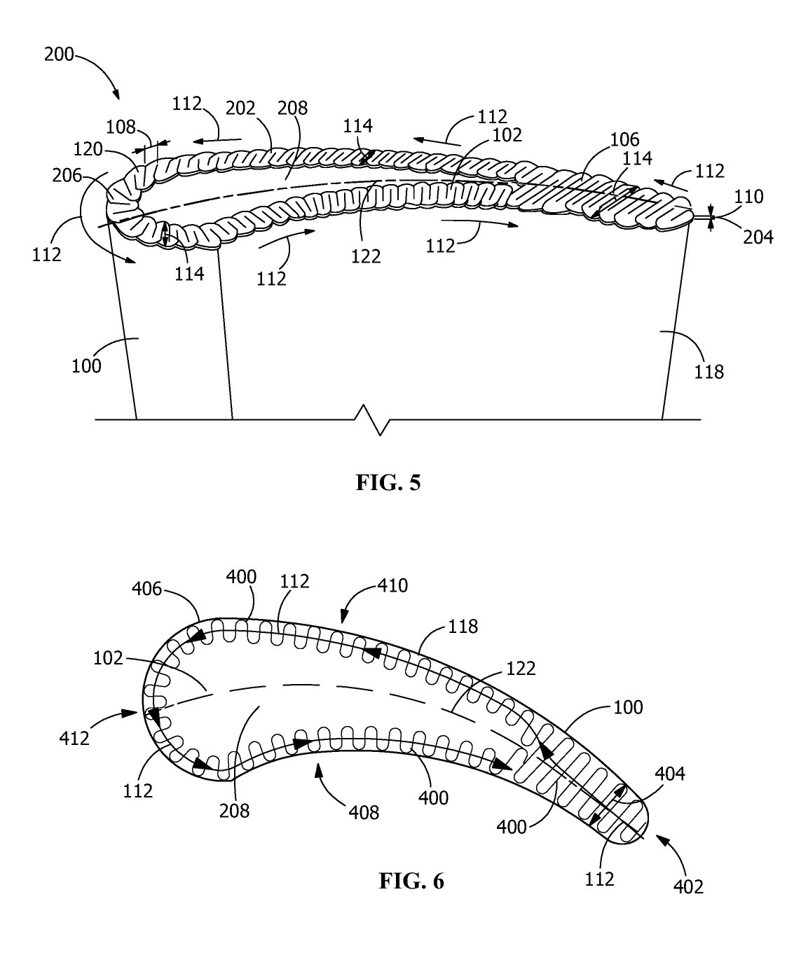

In one embodiment (FIGS. 1-4), the alignment of the oscillating weld path 400 between each turn of the weld path 400 is essentially constant, varying by less than about 15° at each oscillation, alternatively less than about 10°, alternatively less than about 5°, alternatively less than about 1°. In another embodiment (FIGS. 5 and 6), the alignment of the oscillating weld path 400 between each turn of the weld path 400 is maintained essentially perpendicular to the weld direction 112 at that point.

As used herein, the cladding layer 202 being “continuous” indicates that there are no gaps between the oscillations of the weld bead 106 along the weld path 400, but allows that the weld path 400 may be deliberately arranged to establish omitted regions 208 free of the cladding layer 202.

As used herein, “essentially” free of cracks indicates that any cracks are less than about 0.03 inches in largest dimension, alternatively less than about 0.02 inches in largest dimension, alternatively less than about 0.01 inches in largest dimension.

The powder 104 may be applied at any suitable flow rate, including, but not limited to, at a flow rate between about 3 g/min to about 9 g/min, alternatively between about 4 g/min to about 8 g/min, alternatively between about 3 g/min to about 5 g/min, alternatively between about 4 g/min to about 6 g/min, alternatively between about 5 g/min to about 7 g/min, alternatively between about 6 g/min to about 8 g/min, alternatively between about 4.8 g/min to about 5.2 g/min. The flow rate is related to the capture rate of powder 104. The more powder 104 which is captured by the laser welding, the lower the flow rate of the powder 104 may be. Conversely, the lower the rate of capture of the powder 104, the higher the flow rate of the powder 104 should be to compensate.

In one embodiment, the powder 104 is deposited (captured to form the weld bead 106) at a capture rate of between about 40 g/in³ to about 265 g/in³, alternatively between about 44 g/in³ to about 244 g/in³, alternatively between about 60 g/in³ to about 200 g/in³, alternatively between about 65 g/in³ to about 175 g/in³, alternatively between about 70 g/in³ to about 150 g/in³, alternatively between about 75 g/in³ to about 137 g/in³, alternatively between about 40 g/in³ to about 90 g/in³, alternatively between about 65 g/in³ to about 115 g/in³, alternatively between about 90 g/in³ to about 140 g/in³, alternatively between about 115 g/in³ to about 165 g/in³, alternatively between about 140 g/in³ to about 190 g/in³, alternatively between about 165 g/in³ to about 215 g/in³, alternatively between about 190 g/in³ to about 240 g/in³, alternatively between about 215 g/in³ to about 265 g/in³.

In one embodiment, the metal alloy 120 is an HTW alloy. Suitable HTW alloys include, but are not limited to, HAYNES 214. In one embodiment, the metal alloy 120 includes HAYNES 214. In a further embodiment the metal alloy 120 consists essentially of HAYNES 214. As used herein, “consists essentially of” indicates that the inclusion of impurities, the presence of oxidation contaminants, and variances in composition are permissible so long as the properties of the alloy relevant to the alloy's performance in the article, including, but not limited to, melting temperature, oxidation resistance, ductility, and strength, are not negatively and materially affected. In yet a further embodiment, the alloy consists of HAYNES 214.

The laser welding may include any suitable laser energy density, and may be performed with any suitable laser welding apparatus 116. In one embodiment, the laser welding includes the laser welding apparatus 116 imparting a laser energy density of at least about 11 kJ/cm². In a further embodiment the laser energy density is between about 11.5 kJ/cm² to about 20.3 kJ/cm², alternatively between about 15 kJ/cm² to about 20.3 kJ/cm². The laser welding apparatus 116 may emit any suitable beam diameter, including, but not limited to, a beam diameter of between about 0.01 inches to about 0.2 inches, alternatively between about 0.02 inches to about 0.1 inches, alternatively between about 0.03 inches to about 0.08 inches, alternatively between about 0.04 inches to about 0.07 inches, alternatively between about 0.04 inches to about 0.06 inches, alternatively between about 0.045 inches to about 0.065 inches, alternatively between about 0.05 inches to about 0.7 inches, alternatively about 0.05 inches, alternatively about 0.55 inches, alternatively about 0.06 inches. The energy distribution of the laser welding apparatus 116 may include any suitable profile, including, but not limited to, top hat and gaussian. In one embodiment (shown), the laser welding apparatus 116 emits a laser which is about coaxial with the powder 104 as the laser and powder 104 are directed toward the surface 102. In another embodiment (not shown), the laser welding apparatus 116 emits a laser which is off-axis with the powder 104 as the laser and powder 104 are directed toward the surface 102

Laser welding the powder 104 of the metal alloy 120 to the surface 102 of the substrate along the weld path 400 may include any suitable welding speed, including, but not limited to, a welding speed between about 5 ipm to about 20 ipm, alternatively between about 5 ipm to about 15 ipm, alternatively between about 7.5 ipm to about 17.5 ipm, alternatively between about 10 ipm to about 20 ipm, alternatively between about 5 ipm to about 10 ipm, alternatively between about 7.5 ipm to about 12.5 ipm, alternatively between about 10 ipm to about 15 ipm, alternatively between about 12.5 ipm to about 17.5 ipm, alternatively between about 15 ipm to about 20 ipm.

The substrate 100 may be any suitable object, including, but not limited to, a turbine component. Suitable turbine components include, but are not limited to, turbine hot gas path components, turbine buckets 118, turbine nozzles, turbine shrouds, turbine combustors, turbine combustion liners, turbine transition pieces, and combinations thereof. In one embodiment (shown), the substrate 100 is a turbine bucket 118, the article 200 is a turbine bucket 118 including a squealer tip 206, and the cladding layer 202 forms at least a portion of the squealer tip 206. Other embodiments (not shown) include, but are not limited to, wherein the substrate 100 is a turbine bucket 118 and the cladding layer 202 forms at least a portion of an angel wing, wherein the substrate 100 is a turbine bucket 118 and the cladding layer 202 forms at least a portion of the trailing edge 402, wherein the substrate 100 is a turbine nozzle and the cladding layer 202 forms at least a portion of a nozzle edge, and wherein the substrate 100 includes a narrow or sharp feature subject to higher oxidation than the remainder of the substrate 100 and the cladding layer 202 forms the extremity of the narrow or sharp feature.

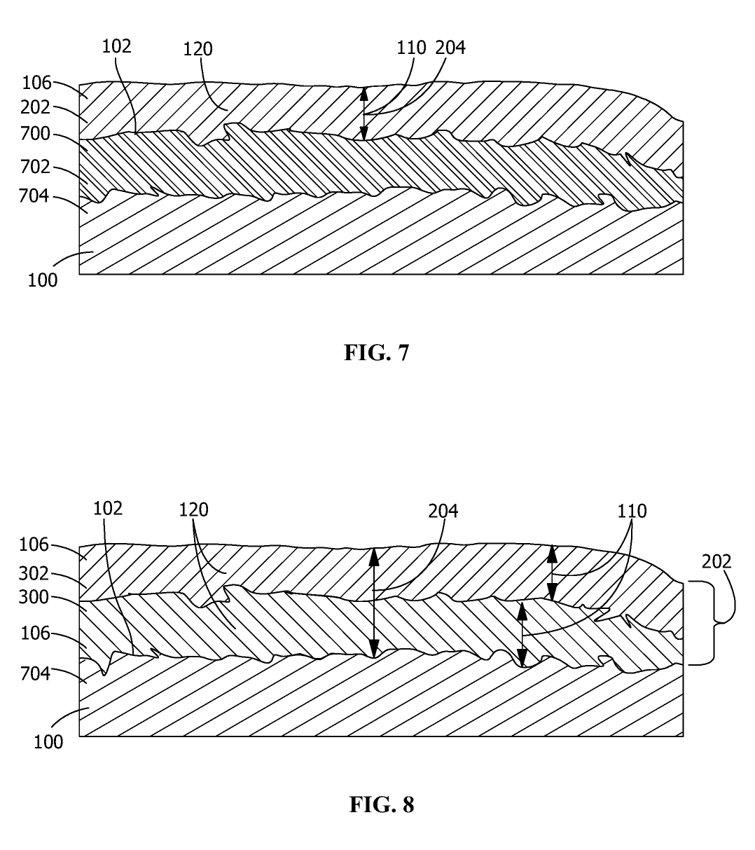

Referring to FIGS. 7 and 8, in one embodiment (FIG. 7), the surface 102 of the substrate 100 includes a surface layer 700 of a surface material 702 compositionally distinct from a material composition 704 of the substrate 100. The surface material may include any suitable alloy composition, including, but not limited to HAYNES 230, INCONEL 625, MERL 72, or combinations thereof In another embodiment (FIG. 8), the surface 102 of the substrate 100 consists essentially of, alternatively consists of, the material composition 704 of the substrate 100, and the powder 104 of the metal alloy 120 is welded directly to the surface 102 of the substrate 100.

The material composition 704 of the substrate 100 may include any suitable composition, including, but not limited to, steels, mild steels, superalloys, nickel-based superalloys, cobalt-based superalloys, GTD 111, GTD 222, INCONEL 718, MAR-M-247, René N4, René N5, René 108, or combinations thereof.

Referring again to FIGS. 4 and 6, in one embodiment, the weld path 400 commences at a trailing edge 402 of the turbine bucket 118, proceeds across a trailing edge width 404 of the trailing edge 402, and then proceeds around a periphery 406 of the turbine bucket 118 along one of a suction side 408 and a pressure side 410, through a leading edge 412, and back along the other of the suction side 408 and the pressure side 410 until returning to the trailing edge 402.

Referring to FIGS. 1, 2, 5, and 7, in one embodiment, forming the cladding layer 202 consists essentially of applying a single layer of the metal alloy 120, and the cladding layer thickness 204 is about the weld bead height 110. As used herein, “consisting essentially of” indicates that the cladding layer 202 itself is formed of the single layer of the metal alloy 120, but allows that additional and compositionally distinct coatings may be applied to the cladding layer 202, and that finishing techniques may be applied to the cladding layer 202, including, but not limited to, machining the cladding layer 202 to achieve net shape, which may reduce the cladding layer thickness 204.

The cladding layer thickness 204 may be any suitable thickness, including, but not limited to between about 0.02 inches to about 0.15 inches, alternatively between about 0.04 inches to about 0.13 inches, alternatively between about 0.07 inches to about 0.1 inches, alternatively between about 0.02 inches to about 0.5 inches, alternatively between about 0.04 inches to about 0.07 inches, alternatively between about 0.06 inches to about 0.09 inches, alternatively between about 0.08 inches to about 0.11 inches, alternatively between about 0.1 inches to about 0.13 inches, alternatively between about 0.12 inches to about 0.15 inches.

Referring to FIGS. 1-3 and 8, in another embodiment, forming the cladding layer 202 includes applying a first layer 300 of the metal alloy 120 to the surface 102 of the substrate 100 by laser welding the powder 104 of the metal alloy 120 to the surface 102 of the substrate 100, and then applying a second layer 302 of the metal alloy 120 to the first layer 300 of the metal alloy 120 by laser welding the powder 104 of the metal alloy 120 to the first layer 300 of the metal alloy 120, such that the cladding layer thickness 204 is greater than the weld bead height 110.

Forming the cladding layer 202 may further include applying at least one additional layer (not shown) of the metal alloy 120 sequentially by laser welding the powder 104 of the metal alloy 120 to a previously applied layer of the metal alloy 120.

Forming the cladding layer 202 by applying at least a first layer 300 and a second layer 302 of the metal alloy 120 may form a cladding layer thickness 204 greater than the maximum weld bead height 110 of a weld bead 106. In one embodiment, the cladding layer thickness 204 is at least about 0.2 inches, alternatively at least about 0.3 inches, alternatively at least about 0.4 inches, alternatively at least about 0.5 inches, alternatively at least about 0.6 inches, alternatively at least about 0.7 inches, alternatively at least about 0.8 inches, alternatively at least about 0.9 inches, alternatively at least about 1 inch, alternatively between about 0.2 inches to about 0.8 inches, alternatively between about 0.3 inches to about 0.7 inches, alternatively between about 0.2 inches to about 0.4 inches, alternatively between about 0.3 inches to about 0.5 inches, alternatively between about 0.4 inches to about 0.6 inches, alternatively between about 0.5 inches to about 0.7 inches, alternatively between about 0.6 inches to about 0.8 inches.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming an article, comprising:
laser welding a powder of a metal alloy to a surface of a substrate along a weld path, forming a weld bead of the metal alloy having a weld bead width and a weld bead height; and
propagating the weld path along a weld direction, forming a cladding layer of the metal alloy disposed on the surface having a cladding layer thickness, wherein:
the metal alloy is a hard-to-weld (HTW) alloy;
the laser welding includes a laser energy density of at least about 11 kJ/cm²;
laser welding the powder of the metal alloy to the surface of the substrate along the weld path includes a welding speed between about 5 ipm to about 20 ipm;
the weld path oscillates essentially nonparallel relative to a reference line, establishing a cladding width wider than the weld bead width;
the weld bead contacts itself along each oscillation such that the cladding layer is continuous; and
the cladding layer is essentially free of cracks.

2. The method of claim 1, wherein the article is a turbine bucket including a squealer tip, and the cladding layer forms at least a portion of the squealer tip.

3. The method of claim 2, wherein the weld path commences at a trailing edge of the turbine bucket, proceeds across a trailing edge width of the trailing edge, and then proceeds around a periphery of the turbine bucket along one of a suction side and a pressure side, through a leading edge, and back along the other of the suction side and the pressure side until returning to the trailing edge.

4. The method of claim 1, wherein the reference line is selected from the group consisting of a weld direction, a center line, a chord line, and combinations thereof.

5. The method of claim 1, wherein the metal alloy includes, by weight:
about 15% to about 17% chromium;
about 4% to about 5% aluminum;
about 2% to about 4% iron;
about 0.002% to about 0.04% yttrium;
up to about 0.5% manganese;
up to about 0.2% silicon;
up to about 0.1% zirconium;
up to about 0.05% carbon;
up to about 0.5% tungsten;
up to about 2% cobalt;
up to about 0.15% niobium;
up to about 0.5% titanium;
up to about 0.5% molybdenum;
up to about 0.01% boron; and
a balance of nickel;

6. The method of claim 1, wherein the surface of the substrate includes a surface layer of a surface material selected from the group consisting of:
an alloy composition including, by weight:
about 21% to about 23% chromium;
about 13% to about 15% tungsten;
about 1% to about 3% molybdenum;
about 0.25% to about 0.75% manganese;
about 0.2% to about 0.6% silicon;
about 0.1% to about 0.5% aluminum;
about 0.05% to about 0.15% carbon;
about 0.01% to about 0.03% lanthanum;
up to about 3% iron;
up to about 5% cobalt;
up to about 0.5% niobium;
up to about 0.1% titanium;
up to about 0.015% boron; and
a balance of nickel;
an alloy composition including, by weight:
about 20% to about 23% chromium;
about 8% to about 10% molybdenum;
about 3.15% to about 4.15% niobium and tantalum;
up to about 5% iron;
up to about 0.1% carbon;
up to about 0.5% manganese;
up to about 0.5% silicon;
up to about 0.015% phosphorous;
up to about 0.015% sulfur;
up to about 0.4% aluminum;
up to about 0.4% titanium;
up to about 1% cobalt; and
a balance of nickel;
an alloy composition including, by weight:
about 14% to about 16% nickel;
about 19% to about 21% chromium;
about 8% to about 10% tungsten;
about 4.0% to about 4.8% aluminum;
about 0.1% to about 0.3% titanium;
about 2% to about 4% tantalum;
about 0.25% to about 0.45% carbon;
about 0.5% to about 1.5% hafnium;
about 0.35% to about 0.55% yttrium; and
a balance of cobalt; and
combinations thereof.

7. The method of claim 1, wherein the substrate includes a material composition, the surface of the substrate consists essentially of the material composition of the substrate, and the powder of the metal alloy is laser welded directly to the surface of the substrate.

8. The method of claim 1, wherein the substrate includes a material composition selected from the group consisting of:
steels;
mild steels;
superalloys;
nickel-based superalloys;
cobalt-based superalloys;
an alloy composition including, by weight:
about 9% to about 10.5% chromium;
about 7% to about 8% cobalt;
about 3.7% to about 4.7% aluminum;
about 3% to about 4% titanium;
about 1% to about 2% molybdenum;
about 5% to about 7% tungsten;
about 4.3% to about 5.3% tantalum;
about 0.3% to about 0.7% niobium;
about 0.1% to about 0.2% hafnium; and
a balance of nickel;
an alloy composition including, by weight:
about 13.5% to about 14.5% chromium;
about 9% to about 10% cobalt;
about 3.3% to about 4.3% tungsten;
about 4.4% to about 5.4% titanium;
about 2.5% to about 3.5% aluminum;
about 0.05% to about 0.15% iron;
about 2.3% to about 3.3% tantalum;
about 1.1% to about 2.1% molybdenum;
about 0.05% to about 0.15% carbon; and
a balance of nickel;
an alloy composition including, by weight:
about 22.5% to about 24.5% chromium;
about 18% to about 20% cobalt;
about 1.5% to about 2.5% tungsten;
about 0.3% to about 1.3% niobium;
about 1.8% to about 2.8% titanium;
about 0.7% to about 1.7% aluminum;
about 0.5% to about 1.5% tantalum;
about 0.15% to about 0.35% silicon;
about 0.05% to about 0.15% manganese; and
a balance of nickel;
an alloy composition including, by weight:
about 17% to about 21% chromium;
about 50% to about 55% nickel and cobalt;
about 4.75% to about 5.5% niobium and tantalum;
about 2.8% to about 3.3% molybdenum;
about 0.65% to about 1.15% titanium;
about 0.2% to about 0.8% aluminum;
up to about 1% cobalt;
up to about 0.08% carbon;
up to about 0.35% manganese;
up to about 0.35% silicon;
up to about 0.015% phosphorous;
up to about 0.015% sulfur;
up to about 0.006% boron;
up to about 0.3% copper; and
a balance of iron;
an alloy composition including, by weight:
about 5.4% to about 5.7% aluminum;
about 8% to about 8.5% chromium;
about 9% to about 9.5% cobalt;
about 9.3% to about 9.7% tungsten;
about 0.05% to about 0.15% manganese;
about 0.15% to about 0.35% silicon;
about 0.06% to about 0.09% carbon; and
a balance of nickel;
an alloy composition including, by weight:
about 7% to about 8% cobalt;
about 6% to about 8% chromium;
about 5.5% to about 7.5% tantalum;
about 5.2% to about 7.2% aluminum;
about 4% to about 6% tungsten;
about 2.5% to about 3.5% rhenium;
about 1% to about 2% molybdenum;
about 0.1% to about 0.2% hafnium; and
a balance of nickel;
an alloy composition including, by weight:
about 7.9% to about 8.9% chromium;
about 9% to about 10% cobalt;
about 5% to about 6% aluminum;
about 0.5% to about 0.9% titanium;
about 9% to about 10% tungsten;
about 0.3% to about 0.7% molybdenum;
about 2.5% to about 3.5% tantalum;
about 1% to about 2% hafnium; and
a balance of nickel; and
combinations thereof.

9. The method of claim 1, wherein the laser energy density is between about 11.5 kJ/cm² to about 20.3 kJ/cm².

10. The method of claim 1, wherein the powder is applied at a flow rate between about 4 g/min to about 6 g/min.

11. The method of claim 10, wherein the flow rate is between about 4.8 g/min to about 5.2 g/min.

12. The method of claim 1, wherein forming the cladding layer consists essentially of applying a single layer of the metal alloy, and the cladding layer thickness is about the weld bead height.

13. The method of claim 1, wherein forming the cladding layer includes applying a first layer of the metal alloy to the surface of the substrate by laser welding the powder of the metal alloy to the surface of the substrate, and then applying a second layer of the metal alloy to the first layer of the metal alloy by laser welding the powder of the metal alloy to the first layer of the metal alloy, such that the cladding layer thickness is greater than the weld bead height.

14. The method of claim 13, wherein forming the cladding layer further includes applying at least one additional layer of the metal alloy sequentially by laser welding the powder of the metal alloy to a previously applied layer of the metal alloy.

15. The method of claim 1, wherein the cladding layer thickness is between about 0.02 inches to about 0.15 inches.

16. The method of claim 15, wherein the cladding layer thickness is between about 0.07 inches to about 0.1 inches.

17. The method of claim 1, wherein the cladding layer thickness is at least about 0.2 inches.

18. The method of claim 1, wherein forming the cladding layer is free of gas tungsten arc welding.

19. A method for forming a turbine bucket including a squealer tip, comprising:
laser welding a powder of a metal alloy to a surface of a substrate along a weld path, forming a weld bead of the metal alloy having a weld bead width and a weld bead height; and
propagating the weld path along a weld direction, forming a cladding layer of the metal alloy disposed on the surface having a cladding layer thickness, wherein:
the metal alloy consists essentially of, by weight:
about 15% to about 17% chromium;
about 4% to about 5% aluminum;
about 2% to about 4% iron;
about 0.002% to about 0.04% yttrium;
up to about 0.5% manganese;
up to about 0.2% silicon;
up to about 0.1% zirconium;
up to about 0.05% carbon;
up to about 0.5% tungsten;
up to about 2% cobalt;
up to about 0.15% niobium;
up to about 0.5% titanium;
up to about 0.5% molybdenum;
up to about 0.01% boron; and
a balance of nickel;
the surface of the substrate includes a surface layer of a surface material selected from the group consisting of:
an alloy composition including, by weight:
about 21% to about 23% chromium;
about 13% to about 15% tungsten;
about 1% to about 3% molybdenum;
about 0.25% to about 0.75% manganese;
about 0.2% to about 0.6% silicon;
about 0.1% to about 0.5% aluminum;
about 0.05% to about 0.15% carbon;
about 0.01% to about 0.03% lanthanum;
up to about 3% iron;
up to about 5% cobalt;
up to about 0.5% niobium;
up to about 0.1% titanium;
up to about 0.015% boron; and
a balance of nickel;
an alloy composition including, by weight:
about 20% to about 23% chromium;
about 8% to about 10% molybdenum;
about 3.15% to about 4.15% niobium and tantalum;
up to about 5% iron;
up to about 0.1% carbon;
up to about 0.5% manganese;
up to about 0.5% silicon;
up to about 0.015% phosphorous;
up to about 0.015% sulfur;
up to about 0.4% aluminum;
up to about 0.4% titanium;
up to about 1% cobalt; and
a balance of nickel;
an alloy composition including, by weight:
about 14% to about 16% nickel;
about 19% to about 21% chromium;
about 8% to about 10% tungsten;
about 4.0% to about 4.8% aluminum;
about 0.1% to about 0.3% titanium;
about 2% to about 4% tantalum;
about 0.25% to about 0.45% carbon;
about 0.5% to about 1.5% hafnium;
about 0.35% to about 0.55% yttrium; and
a balance of cobalt; and
combinations thereof;
the laser welding includes a laser energy density of between about 11.5 kJ/cm² to about 20.3 kJ/cm²;
laser welding the powder of the metal alloy to the surface of the substrate along the weld path includes a welding speed between about 5 ipm to about 20 ipm;
the powder is applied at a flow rate of between about 4.8 g/min to about 5.2 g/min;
the weld path oscillates essentially nonparallel relative to a reference line, establishing a cladding width wider than the weld bead width;
the reference line is selected from the group consisting of a weld direction, a center line, a chord line, and combinations thereof;
the weld bead contacts itself along each oscillation such that the cladding layer is continuous;
the cladding layer is essentially free of cracks;
the cladding layer forms at least a portion of the squealer tip;
the weld path commences at a trailing edge of the turbine bucket, proceeds across a trailing edge width of the trailing edge, and then proceeds around a periphery of the turbine bucket along one of a suction side and a pressure side, through a leading edge, and back along the other of the suction side and the pressure side until returning to the trailing edge;
the cladding layer thickness is at least about 0.2 inches; and
forming the cladding layer is free of gas tungsten arc welding.

20. A turbine bucket, comprising:
a squealer tip, wherein:
the squealer tip includes a cladding layer consisting essentially of, by weight:
about 15% to about 17% chromium;
about 4% to about 5% aluminum;
about 2% to about 4% iron;
about 0.002% to about 0.04% yttrium;
up to about 0.5% manganese;
up to about 0.2% silicon;
up to about 0.1% zirconium;
up to about 0.05% carbon;
up to about 0.5% tungsten;
up to about 2% cobalt;
up to about 0.15% niobium;
up to about 0.5% titanium;
up to about 0.5% molybdenum;
up to about 0.01% boron; and
a balance of nickel;
the cladding layer is essentially free of cracks; and
the cladding layer includes a cladding layer thickness of at least about 0.2 inches.
